(19) United States
(12) Patent Application Publication
(10) Pub. No.: US 2013/0043087 A1
(43) Pub. Date: Feb. 21, 2013

(54) MOTOR VEHICLE BODY

(71) Applicant: Udo MILDNER, Limburg (DE)

(72) Inventor: Udo MILDNER, Limburg (DE)

(73) Assignee: GM GLOBAL TECHNOLOGY OPERATIONS LLC, Detroit, MI (US)

(21) Appl. No.: 13/589,227

(22) Filed: Aug. 20, 2012

(30) Foreign Application Priority Data
Aug. 20, 2011 (DE) 10 2011 111 236.0

(51) Int. Cl. B62D 25/08; B62D 21/00

(52) U.S. Cl. 180/291; 296/193.09; 180/377

(57) ABSTRACT

A support structure for a motor vehicle body includes, but is not limited to a side member extending between an engine compartment and a wheel installation space, a wheel installation brace running above the wheel installation space and a unitary stiffening element extending above the wheel installation space and connecting the wheel installation brace with the side member, on which one or a plurality of fastening points for the attachment of an engine and/or transmission mounting are formed.

### CROSS-REFERENCE TO RELATED APPLICATION

This application claims priority to German Patent Application No. 10 2011 111 236.0, filed Aug. 20, 2011, which is incorporated herein by reference in its entirety.

### TECHNICAL FIELD

The technical field relates to the bodywork of a motor vehicle body, in particular the front region of such a body.

### BACKGROUND

The supporting parts of a motor vehicle body are connected in a fixed manner both to engine and transmission as well as to a passenger cell of the vehicle and are well suited for transmitting vibrations of the engine and of the transmission to the passenger cell. In order to avoid this leading to extreme noise pollution in the passenger cell it is known to provide vibration dampers between engine and transmission on the one hand and passenger cell on the other hand, and to arrange fastening points via which the engine and transmission are connected to the supporting bodywork parts so that they can preferably conduct away only a preferably minor part of the vibration. Examples for such engine mountings are found, for example, in US 2003/0136601 A1 or U.S. Pat. No. 5,466,033.

On the one hand, the supporting parts of a motor vehicle body are to be as light as possible in weight in order to make possible a fuel-saving operation of the vehicle, while on the other hand they must have a high stiffness in order to impart to the body the torsional rigidity for normal driving operation and ensure an effective occupant protection in the event of accidents. In addition, those parts of the body outer skin, which could be struck by a passenger during an accident, should be yielding and spaced away from vehicle parts which are not deformable in the event of an accident involving a pedestrian such as for example supporting structures of the body or an engine block so far that they can continuously decelerate the impact of the pedestrian and prevent his/her striking through onto the non-deformable parts. However, the more distant the supporting bodywork parts have to be from the vehicle outer skin in order to satisfy the requirements of the pedestrian protection, the more rigid and heavier must these be in order to be able to guarantee a required torsional rigidity of the body.

Since any weight increase, on the one hand because of material costs, on the other hand because of an increased fuel requirement due to weight, brings with it costs for a user of the motor vehicle, there is a need for proposals as to how the weight of a motor vehicle body can be reduced while maintaining or even improving stiffness while adhering to the need for pedestrian protection at the same time.

In view of the foregoing, at least one object is to supply such a proposal. In addition, other objects, desirable features and characteristics will become apparent from the subsequent summary and detailed description, and the appended claims, taken in conjunction with the accompanying drawings and this background.

### SUMMARY

A support structure is provided for a motor vehicle body having a side member extending between an engine compartment and a wheel installation space, a wheel installation brace running above the wheel installation space and a one-piece stiffening element extending over the wheel installation space and connecting the wheel installation brace with the side member, one or a plurality of fastening points for the fastening of an engine or transmission mounting are formed on the stiffening element.

The stiffening element can practically comprise an L-like or T-like shape with a longitudinal section extending over the side member and fastened to the side member distributed in longitudinal direction and a cross section having a distal end running from the longitudinal section in transverse direction and fastened to the wheel installation brace. Preferentially, at least one of the fastening points is provided on the transverse section. In particular, when the latter rises towards the wheel installation brace, a statically favorable connecting point for the engine mounting located high up can be created in this manner. In order to optimize the bending stiffness of the stiffening element, at least one bead continuously extends preferentially between the longitudinal section and the transverse section.

The longitudinal section can comprise flanges angled off in opposite directions fastened to the side member on both sides of a center piece. Such a structure is particularly suited for fastening to a side member, which in turn is assembled from an inner panel bent hat-like located towards the engine compartment and a closing plate facing the wheel installation space and welded to the rims of the hat-shaped inner panel, for one of the flanges can be welded to one of the upper rims and the other to a center piece of the inner panel.

The longitudinal section of the stiffening element can be corrugated in longitudinal section; between two peaks of the longitudinal section each comprising the fastening points a trough touching the side member and supporting itself on the latter can be formed. In order to stabilize the transverse section between side member and wheel installation brace, said transverse section can practically comprise a flange on a side facing the passenger cell, which is fastened to a spring strut mounting. Preferentially, the transverse section and a reinforcing part extending between the wheel installation brace and the side member complement each other into a hollow profile.

The flange of the transverse section can be fastened to the spring strut mounting in particular via a flange of the reinforcing part. The reinforcing part can be extended as far as to below the side member in order to form a support that acts on an engine frame or auxiliary frame. In order to securely fix the engine carrier with little use of material, the fastening points are to be practically located not on a line but define the corners of a triangle.

### BRIEF DESCRIPTION OF THE DRAWINGS

The present invention will hereinafter be described in conjunction with the following drawing figures, wherein like numerals denote like elements, and:

FIG. 1 is a perspective view of parts of a motor vehicle body according to an embodiment;

FIG. 2 is an enlarged detail from FIG. 1;

FIG. 3 is a stiffening element of the motor vehicle body;

FIG. 4 is the stiffening element together with an inner plate of a side member;

FIG. 5 is a closing plate of the side member with a spring strut mounting and a complementary reinforcing part following said closing plate;

FIG. 6 is a cross section through the structure shown in FIG. 2; and

FIG. 7 is a second cross section along a sectional plane displaced in parallel to the plane of FIG. 6.

### DETAILED DESCRIPTION

The following detailed description is merely exemplary in nature and is not intended to limit application and uses. Furthermore, there is no intention to be bound by any theory presented in the preceding background or summary or the following detailed description.

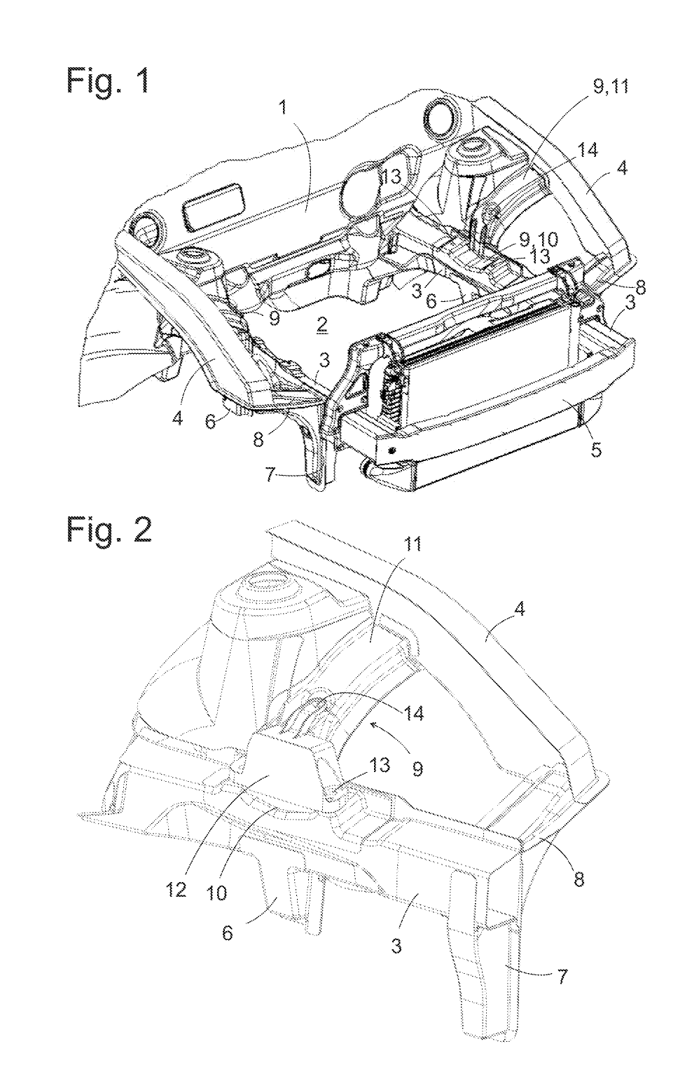

With the motor vehicle body partially shown in FIG. 1, two side members 3 and two wheel installation braces 4 extend forward from a front wall 1, which separates the engine compartment 2, shown empty here without engine and transmission therein, from a passenger cell located behind it. At their front ends, the side members 3 are connected by a bumper 5. Supports 6, 7 extending downwards from the side members 3 act via vibration-damping rubber buffers which are not shown on an auxiliary frame, also called engine frame, which is likewise not shown, which closes off the engine compartment to the bottom and carries engine, transmission and front axle of the vehicle. Arms 8, obliquely raising upwards to the outside in extension of the front supports 7 hold the peaks of the wheel installation braces 4.

In a middle region, the wheel installation braces 4 are each supported by a stiffening element 9. The stiffening element 9 is approximately T-shaped in top view, with a longitudinal section 10 extending on the side member 3 and a transverse section 11 extending in an arc from the side member 3 to the wheel installation brace 4. The stiffening element 9 is unitarily deep-drawn from a sheet metal blank. Two fastening points 13 for attaching a bearing pedestal 12 shown in FIG. 2 and supporting engine and transmission in lateral direction are formed on the longitudinal section 10; a third fastening point 14 is located on the transverse section 11 opposite the previously mentioned ones, offset vertically and in vehicle transverse direction.

As is evident in particular by the enlarged representation of the stiffening element 9 in FIG. 3, the longitudinal section 10 comprises two flanges 15 and 16 which are substantially oriented vertically and, between the flanges 15, 16, a middle region running wave-shaped in vehicle longitudinal direction, which is divided into horizontal sections 17, 18, 19, which in the assembled state rest on the side member 3, horizontal sections 20, 21 spaced from the side member 3, in which the fastening points 13 are formed, as well as inclines continuously connecting these sections. Two beads 22 extend across the flange 16 as far as into the transverse section 11 following thereon. At its outer end, the transverse section 11 carries an angled-off flange 23 for welding to the wheel installation brace 4. The transverse section 11 is divided in cross section into four sections similar to a W, a substantially vertical flange 24 on its side facing the front wall 1, a substantially horizontal wall 25 in cross section, a vertical wall 26 and a second approximately horizontal flange 27.

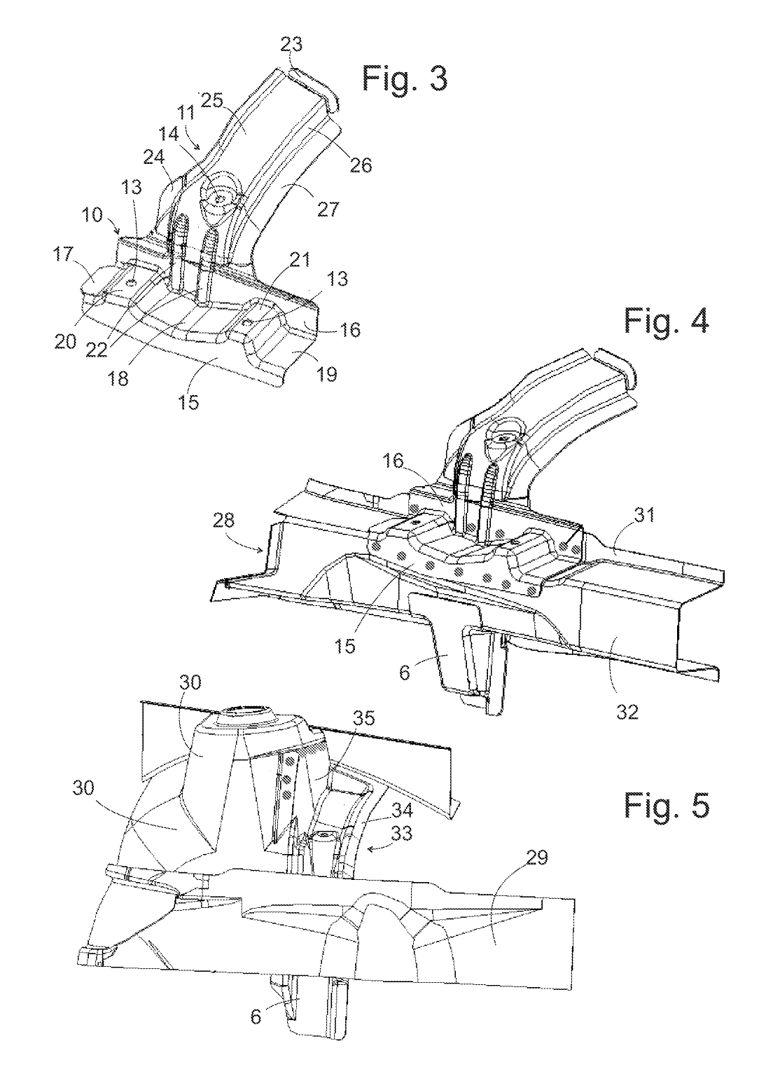

FIG. 4 and FIG. 5 illustrate the attachment of the stiffening element 9 in the body. For the sake of clearer representation, an inner profile 28 of the side member 3 that is hat-shaped in cross section and a closing plate 29 of the latter are shown separately from each other although at the time of the installation of the stiffening element 9, these are already connected in a fixed manner to each other into side member 3 and to a wheel installation housing 30. As is evident in FIG. 4, the flanges 15, 16 of the stiffening element 9 hug an upper welding flange 31 of the inner profile 28 as well as a middle vertical wall section 32 of the latter facing the engine compartment 2 where they are welded together.

The wheel installation housing 30 fills out an intermediate space, which towards the engine compartment 2 is limited by the closing plate 29 of the side member 3, in vehicle transverse direction towards the outside by the wheel installation brace 4, towards the back by the front wall 1 and towards the front by a reinforcing part 33, which extends in an arc from the outside of the support 6 as far as to the wheel installation brace 4. By welding the flanges 24, 27 of the stiffening element 9 to corresponding flanges 34, 35 of the reinforcing part 33, a hollow member that can be subjected to a high load with low weight is created between the side member 3 and the wheel installation brace 4.

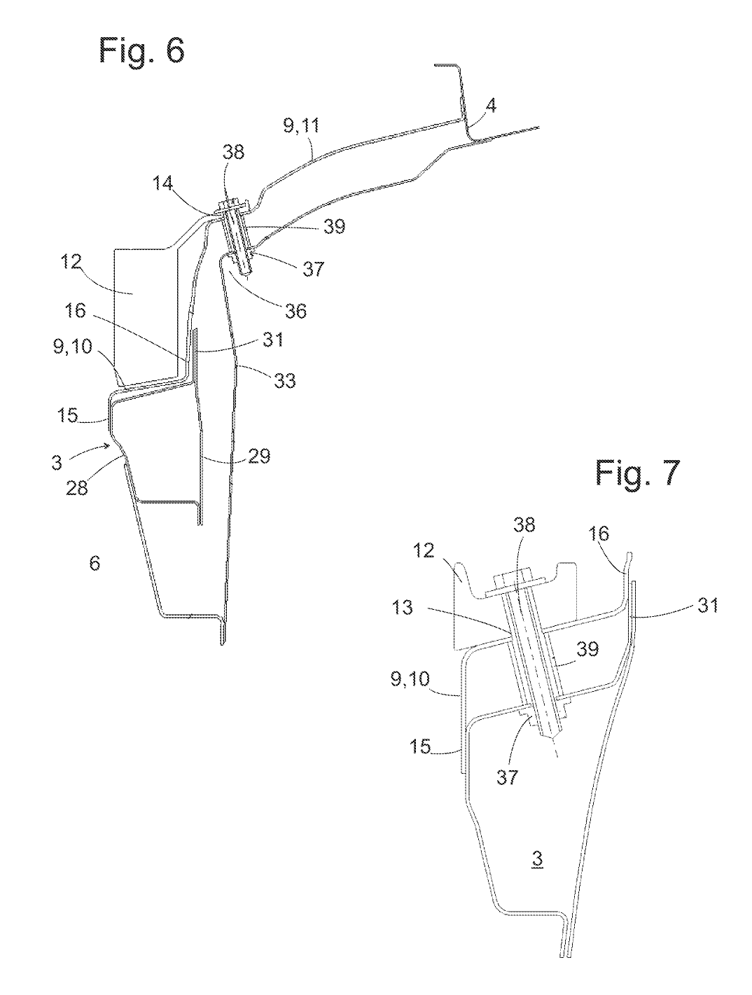

FIG. 6 shows a section in vehicle transverse direction through the side member 3, the stiffening element 9, the reinforcing part 33 and a part of the wheel installation brace 4. In the reinforcing part 33, a protrusion 36 is tightened opposite the fastening point 14, on the inside of which a welding nut 37 is attached. A screw 38 fixing the bearing pedestal 12 is held in the welding nut 37; a sleeve 39 surrounding the screw 38 stabilizes the distance between the stiffening element 9 and the reinforcing part 33 and prevents a deformation during the tightening of the screw 38. In a corresponding manner, a welding nut 37 is attached in the interior of the side member 3 in FIG. 7, which shows a cross section at the height of one of the fastening points 13 of the longitudinal section 10, and the distance between the top of the side member 3 and the longitudinal section 10 is stabilized through a sleeve 39 surrounding the screw 38.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A support structure for a motor vehicle body, comprising:
a side member extending between an engine compartment and a wheel installation space;
a wheel installation brace running above the wheel installation space;
a unitary stiffening element extending above the wheel installation space and connecting the wheel installation brace to the side member,
a fastening point that is configured for attachment of a mounting formed on the unitary stiffening element.

2. The support structure according to claim 1, wherein the mounting is an engine mounting.

3. The support structure according to claim 1, wherein the mounting is a transmission mounting.

4. The support structure according to claim 1, wherein the unitary stiffening element comprises:
a longitudinal section extending above the side member and fastened distributed in longitudinal direction to the side member;
a transverse section extending from the longitudinal section in a transverse direction; and
a distal end fastened to the wheel installation brace.

5. The support structure according to claim 4, wherein the fastening point is provided on the transverse section.

6. The support structure according to claim 4, wherein a bead extends in a substantially continuous manner between the longitudinal section and the transverse section.

7. The support structure according to claim 4, wherein the longitudinal section comprises a flange angled off in opposite directions on both sides of a center piece fastened to the side member.

8. The support structure according to claim 7, wherein the longitudinal section is corrugated in the longitudinal section and between two peaks each comprising one of the fastening point comprises a trough touching the side member.

9. The support structure according to claim 4, wherein the transverse section on a side facing a passenger cell comprises a flange fastened to a spring strut mounting.

10. The support structure according to claim 9, wherein the transverse section and a reinforcing part extending between the wheel installation brace and the side member is configured to complement each other into a hollow profile.

11. The support structure according to claim 10, wherein the flange of the transverse section is fastened to the spring strut mounting via the flange of the reinforcing part.

12. The support structure according to claim 10, wherein the reinforcing part extends as far as to below the side member in order to form a support that acts on an engine frame.

13. The support structure according to claim 1, wherein the fastening point define corners of a triangle.
